(19) United States
(12) Patent Application Publication
(10) Pub. No.: US 2007/0215262 A1
(43) Pub. Date: Sep. 20, 2007

(54) Lottery ticket printed on an embossed foil layer

(76) Inventors: Brett Taylor, Winnipeg (CA); Scott Jevne, Winnipeg (CA); Inanama Mejos, Winnipeg (CA)

Correspondence Address: ADE & COMPANY INC., 2157 Henderson Highway, WINNIPEG, MB, R2G1P9, CA

(21) Appl. No.: 11/365,806

(22) Filed: Mar. 2, 2006

(30) Foreign Application Priority Data
Mar. 1, 2006 (CA) 2,537,196

(51) Int. Cl. B32B 37/00

(52) U.S. Cl. 156/64

(57) ABSTRACT

A lottery ticket has a substrate layer with game data printed in a game area and has at least one fixing layer applied over the game data in the game area so as to prevent release of the printed game data from the substrate layer and at least one opaque scratch-off layer applied over the fixing layer, the scratch-off layer being arranged such that it separates from the fixing layer and breaks down into fragments when scratched by a player. The ticket is modified by printing the game area onto a substrate which is formed by a card stock which carries an embossed foil so that the printing covers the ribs and grooves of the embossed foil while providing a complete layer for securing the game data against viewing prior to scratching.

The present invention relates generally to the field of game or lottery tickets which include a scratch-off layer covering game indicia which can be exposed by the player removing the layer for playing of the game or lottery.

The game of the lottery ticket of the present invention provided on each substrate sheet may be for prizes both monetary and product related or may be merely for entertainment where no gambling or prize is involved. The type and value of any prizes can vary widely. The games may be predetermined, otherwise known as “instant win” tickets or may include elements of skill or chance.

The games of the lottery tickets concerned are preferably instant win type games where the result is entirely predetermined, since such games are generally preferred in a lottery situation in order to ensure that the total winnings is predetermined. However the present invention is not limited to the type of game to be played and can include probability or other games which include game indicia covered by a scratch-off coating.

The lottery ticket may also be used in situations where the main objective is for other purposes than gambling such as in promotional games or games of fun for children or others where no gambling or prizes are involved.

Many such lottery tickets are used directly in a lottery situation so that the tickets have no other relevance other than the playing of the lottery or game by which the player may win monetary or other prizes as part of the lottery or gaming situation. However attention has been recently given to other uses of such lottery tickets such as promotional items used by manufacturers of other products to enhance the sale of the product, or as part of packaging or in other situations where the substrate acts in another capacity and the lottery ticket aspect is merely one part of its function.

The marketing of lottery tickets is primarily based on the psychology of impulse buying so that the ticket itself must be inherently attractive to the potential customer sufficiently to trigger the sale. Particular attention is therefore applied to generating attractive graphics and an attractive appearance of the game face of the ticket.

For this reason high quality graphics and full four colour printing are commonly used in the printing of the product, but of course are not essential as more simpler appearances can be used. If used, this is of particular importance over the area at the game data.

Tickets of this type primarily utilize scratch-off technology for covering the game data and techniques for applying the scratch-off coating in a manner which provides the necessary protection and security for the game data have become well established. On top of the scratch-off coating it is common to print additional graphics, often in four colour printing for the purposes of providing the required attractive appearance of the ticket.

It is also known that foil can be used on lottery tickets to provide a reflective appearance which yet further enhances the attractiveness and eye-appeal of the product concerned.

Up until now many such tickets have been manufactured utilizing a plain foil substrate. The printing is then applied on to the foil, with the printing including the necessary coatings for defining the game area, for applying the game indicia and for covering the game indicia with a secure scratch-off coating.

This technique is common using plain foil as the substrate and such tickets are widely used. However the plain foil has by itself little attractiveness since it is merely matt or plain and has no complex reflective patterns.

One approach to improve the attractiveness of the substrate is to use a holographic substrate on which the printing is applied. However holographic substrates are very expensive and thus such tickets printed onto holographic substrates carry a very high cost and are limited to high end products or special events such as Christmas tickets. While such tickets have been manufactured, the improvement in attractiveness has generally been judged insufficient to warrant the considerable extra additional expense of utilizing the holographic substrate

Holographic substrates while having a shiny metal appearance are in fact not foil. Rather they are produced by a metalized transfer method. In the initial stage, clear film is transported over aluminum vapors (metalizing process) which deposits a very thin layer of aluminum particles onto the film surface. The film is then embossed using a metal shim. This results in light diffraction causing the appearance of different colors or shades. The film must then be laminated on to a cardstock backer. This is done by applying a layer of adhesive to the cardstock and then bringing the metalized surface of the film into contact with the adhesive in a nip. The clear film carrier is then removed from the surface leaving the metalized surface with the design. The surface of the holographic material is smooth and is similar in this respect to the surface of plain foil.

It is important to note that the holographic material is not totally opaque unlike a foil. This difference causes problems from a security perspective making holographic material harder to work with since one must achieve both quality graphics and ticket security.

Embossed foils are available and such embossed foil or cardstock has been used previously in the consumer product industry to create special effects or to emphasize the particular product. For example a leather-like pattern can be used for products related to football since it shows surface features similar to a football. In some cases the embossing is actually done after the printing process in order to eliminate the problems associated with ink flow over a course or textured surface and to have the embossing appear in only certain areas. In other cases the foil itself may be tinted prior to the embossing process, once again eliminating the need for printing onto a courser surface. In other cases within the consumer product industry the information to be printed onto the container is actually printed onto labels which are then adhered to the surface of previously embossed foils during the fabrication process.

In contrast to conventional consumer products which have used embossed foil, the manufacture of lottery tickets requires a high level of sophistication to ensure the proper levels of security. The ticket must be immune to attack by various techniques including high levels of reflected or transmitted light, attempts to lift or perforate the scratch off coating, chemical or liquid attacks, all of which are designed to expose the game data without removing the scratch-off coating. Many such lottery tickets have high prize values so that the incentive to breach the security is very high. Certain laboratories have therefore been established to attempt to breach the security of all lottery tickets with only those that pass the rigorous testing being acceptable for sale to the marketplace.

Yet further it is necessary for lottery tickets to have a shelf life of up to two years without degradation of the product leading to the security being breached or the scratch-off coating being difficult to remove.

In order therefore to manufacture an acceptable ticket it is necessary to provide all of the above features.

### SUMMARY OF THE INVENTION

It is one object of the present invention therefore to provide an improved lottery ticket which simulates the appearance of a metal holograph without the high costs of the holographic materials or the use of additional processing costs to achieve a comparable level of security.

According to one aspect of the invention there is provided a method of manufacturing a lottery ticket comprising:

providing a substrate layer of a cardstock;

applying onto a front face of the cardstock a metal foil such that the foil has a rear surface in contact with the front face of the card stock and a front surface;

embossing the metal foil such that there are defined thereon raised portions where the foil is displaced toward the front surface to provide a raised area on the front surface and recessed portions where the foil is displaced toward the rear surface to provide a recessed area on the front surface;

the raised portions and the recessed portions being arranged in patterns to provide an attractive appearance at the front surface;

defining a game area on the front surface of the foil;

printing indicia defining game data on the front surface of the foil or on a coating applied to the front surface of the foil in the game area;

applying at least one fixing layer over the game data in the game area which is arranged to prevent release of the printed game data from the front surface of the foil;

and applying at least one opaque scratch-off layer over the at least one fixing layer,

wherein the game data, the one or more coatings, the at least one fixing layer and the at least one opaque scratch-off layer are printed onto the front surface of the foil such that they enter some of the recessed areas on the front surface and they extend across some of the recessed areas and some of the raised areas on the front surface of the foil to form a front surface of the at least one opaque scratch-off layer which is continuous so as to properly hide the game data from inspection prior to scratching the at least one scratch-off layer.

The term “lottery ticket” used herein can include all of the alternative uses and constructions defined hereinbefore.

The embossing process may or may not cause the raised or recessed images on the rear to be evident. This depends on how the embossing cylinders are setup. If the embossed image is shallow then a male only die is used and the recessed areas are compressed into the surface. A more pronounced image requires the use of male and female dies which deflection in both directions.

The foil is embossed after the lamination process. The foil layer is inherently weak and would not stand up to the pressures of embossing unsupported. Further the foil layer itself could not be embossed easily because of the lack of cushion within the material itself. Once laminated the cardstock backer provides a cushion into which the emboss die can push the foil under pressure. By contrast the holographic material is pre-embossed prior to lamination.

Typical embossed foil is known where the foil is embossed such that the raised portions are displaced relative to the recessed portions by a distance of the order of 0.001 inch. Embossing depths of the order of 0.005 inch can be used but after that depth, there is considerable difficulty in maintaining the integrity of the coatings over the embossment leading to breakdown of the necessary security.

Preferably the foil is embossed such that the raised portions are displaced relative to the recessed portions to form grooves and ribs on the front surface which are arranged in a suitable pattern or in certain direction so as to provide desirable and attractive differences in reflection of light from the surface. However the patterns may involve larger areas than grooves and ribs.

Steps can be taken to help to improve print spread and these can be to use an ink of lower viscosity, that is it includes more fluid, the use of cushioned backers which thus conform more closely to the surface, or the use of lower durometer plates which also help to conform to the surface.

According to a second aspect of the invention there is provided a lottery ticket when manufactured by a method as defined above.

One of the difficulties with embossed foils is that little cracks in the game data area, which are completely unacceptable, are caused by the inks and coatings not being able to be distributed evenly over the entire surface of the foil. Conventionally a person skilled in the art would expect that the printing techniques and materials designed for the application of inks and coatings onto a smooth, continuous surface would not be acceptable with embossed foil. That is, the relief pattern caused by the embossing could result in portions of the hidden security patterns and even portions of the game data itself being visible prior to removal of the scratch-off coating. The end result would be expected to be a ticket which does not meet the stringent requirements of the lottery industry.

Thus in the embossed foil method disclosed herein, a thin layer of aluminum foil is laminated to a cardstock backer and then the foil surface is embossed using a cylinder to create fine depressions in the foil itself. Embossed foil is embossed with a design which creates an uneven texture to the surface of the stock.

The difficulty with embossed surfaces is that there is now an uneven surface onto which the various inks and coatings must be applied. Depending on the depth of the embossing itself this can create multiple levels with the surface of the stock. In our prototypes done to date on those foils with a typically heavier embossed appearance, i.e. leather-like, the surface of the foil contained depressions into which the inks may not flow. However the selection of inks of suitable viscosity and flow characteristics of the ink is done in order to increase the ability of the ink to flow into the crevices and cracks prior to the drying process which avoids leaving voids or defects in the printed surface. This type of surface variation is not present in traditional foil or holographic materials.

Traditional and instant lottery ticket printing has always focused on smooth surfaces to achieve the best appearance. Within the paper industry smoothness is one of the factors that is typically measured during production and quality assurance testing of the finished product.

In regards to the lottery industry there are some unique characteristics based on the products we produce. The tickets must be secure and even though the surface is not flat the security coatings must be evenly applied in order to maintain the integrity of the product coating to ensure that the game data is not discernible.

Also the introduction of a textured surface can introduce problems associated with scratching of the ticket. The removal of the scratch-off, especially with a coin, works best when the surface is very smooth. Variations in the surface of the product can result in the coin or removal device digging into the stock surface causing a tear. Care must be taken in the selection of the embossment of the foil to maintain the textured surface overall and yet have a game surface which performs in relation to the removal of the scratch-off equally to those tickets printed onto a completely smooth layer.

However the advantage of the embossed foil alternative is that it does have some of the reflective characteristics of the holographic foil but at a substantially lower price. For comparison purposes, the embossed foil material can be 40% more than plain foil while the holographic stock may be as much as 320% more.

### BRIEF DESCRIPTION OF THE DRAWINGS

One embodiment of the invention will now be described in conjunction with the accompanying drawings in which:

FIG. 1 is a schematic illustration showing the layers of a lottery ticket product according to the invention.

In the drawings like characters of reference indicate corresponding parts in the different figures.

### DETAILED DESCRIPTION

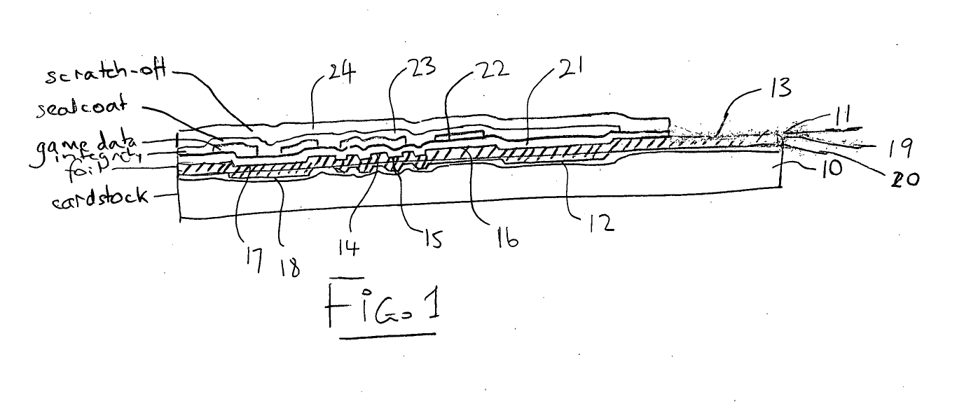

In FIG. 1 is shown a schematic illustration in cross section of a lottery ticket according to the present invention where there is a basic card stock 10 on which is laminated a foil 11. The foil 11 has embossed areas 12 which define a pattern having a visual attractiveness. A portion 13 of the foil is exposed to view so that the embossed areas are visible to the potential purchaser of the ticket to provide an attractive appearance from the patterning visible on the foil. The embossing can provide a simple pattern over the whole area or the pattern may vary. The embossment may include ribs 14 and recesses 15. Larger areas of embossment may also be provided as indicated at 16. The foil is embossed so that the top surface 17 and the bottom surface 18 are both distorted out of the common plane 19 of the foil. Thus the layer of foil is physically distorted rather than merely compressed. This distortion of the foil is partly taken up in a layer 20 of an adhesive which attaches the foil to the card stock 10 and also is partly taken up by distortion of the card stock. Thus the upper surface 17 of the foil displays recessed and raised portions in the embossed pattern.

On top of the foil is applied an integrity layer 21 which can comprise a number of separate printed layers. These generally consist in regard to foil of simply a white lily pad since the foil itself reduces the ability of the potential fraudster from inspecting the game data from the rear of the ticket through the card stock and the foil. Such integrity layers are well known to persons skilled in the art and are widely used on the printing of lottery tickets. On top of the integrity layer is provided the game data 22 applied by an ink jet printer using a computer controlled system to print the game date from selected game data options to ensure that the ticket is either a winning ticket or a losing ticket as predetermined by the printing process. Over the game date is applied a seal coat 23 which seals the game data to ensure that the game data is not removable from the ticket. The seal coat can include various layers including varnishes and other materials which again are well known to a person skilled in the art. The seal coat thus provides a hard layer which remains in place and allows a scratch-off layer 24 to be removed. The scratch-off layer again is formed from one or more layers of latex material which again are well known to a person skilled in the art and are printed over the seal coat layer in a manner which allows the scratch-off coating to be removed to expose the game data visible through the transparent seal coat layer.

The printing materials are selected so that they can print into the recesses in the embossed foil. The recesses provide channels into which the printing ink can run. The viscosity of the inks must therefore be selected so that the inks enter the recessed areas and provide a proper attachment to the foil within the recessed areas and over the raised areas to ensure that the printed layer is integral without cracks. This selection applies to the integrity layer 21, the seal coat 23 and the scratch-off 24, all of which must be integral and without breaks or cracks which would interfere with the security of the ticket.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of manufacturing a lottery ticket comprising:
providing a substrate layer of a cardstock;
applying onto a front face of the cardstock a metal foil such that the foil has a rear surface in contact with the front face of the card stock and a front surface;
embossing the metal foil such that there are defined thereon raised portions where the foil is displaced toward the front surface to provide a raised area on the front surface and recessed portions where the foil is displaced toward the rear surface to provide a recessed area on the front surface;
the raised portions and the recessed portions being arranged in patterns to provide an attractive appearance at the front surface;
defining a game area on the front surface of the foil;
printing indicia defining game data on the front surface of the foil or on a coating applied to the front surface of the foil in the game area;
applying at least one fixing layer over the game data in the game area which is arranged to prevent release of the printed game data from the front surface of the foil;
and applying at least one opaque scratch-off layer over the at least one fixing layer,
wherein the game data, the one or more coatings, the at least one fixing layer and the at least one opaque scratch-off layer are printed onto the front surface of the foil such that they enter some of the recessed areas on the front surface and they extend across some of the recessed areas and some of the raised areas on the front surface of the foil to form a front surface of the at least one opaque scratch-off layer which is continuous so as to properly hide the game data from inspection prior to scratching the at least one scratch-off layer.

2. The method according to claim 1 wherein the foil is embossed such that the raised portions are displaced relative to the recessed portions by a distance of the order of 0.001 to 0.005 inch.

3. The method according to claim 1 wherein the foil is embossed such that the raised portions are displaced relative to the recessed portions to form grooves and ribs on the front surface.

4. A lottery ticket when manufactured by a method according to claim 1.

5. A lottery ticket when manufactured by a method according to claim 2.

6. A lottery ticket when manufactured by a method according to claim 3.
